(19) United States
(12) Patent Application Publication
(10) Pub. No.: US 2024/0045673 A1
(43) Pub. Date: Feb. 8, 2024

(54) METHOD AND SYSTEM FOR HYBRID PIPELINED-DATA FLOW PACKET PROCESSING

(71) Applicant: NVIDIA Corporation, Santa Clara, CA (US)

(72) Inventor: Shirish Bahirat, Longmont, CO (US)

(21) Appl. No.: 17/879,695

(22) Filed: Aug. 2, 2022

(51) Int. Cl. G06F 9/30; G06F 9/38

(52) U.S. Cl. CPC G06F 9/3001; G06F 9/3867

(57) ABSTRACT

Methods, devices, systems, and computer program products to provide a hybrid pipelined-data flow packet processing architecture by normalizing sequential and parallel data paths along with scaling in network compute and stateful network flows. The method includes receiving state data, policy data, scheduling data, and/or dataflow operation data. The method also includes processing data packets based on configured or dynamically updated states, policies, scheduling, and dataflow operations. The method includes performing arithmetic logic unit (ALU)/program execution operations on the data packets based on incoming and outgoing data and control planes. The method also includes intelligently configuring a packet processing flow based on at least one of the state data, the priority data, the scheduling data, and the dataflow operation data.

### FIELD OF TECHNOLOGY

The present disclosure relates to packet processing. More specifically, the present disclosure relates to a hybrid pipelined-data flow packet processing architecture by normalizing sequential and parallel data paths along with scaling in network compute and stateful network flows.

### BACKGROUND

Packet processing refers to a variety of algorithms that may be applied to a packet of data or information as the packet moves through various network elements of a communications network. Traditionally, packet processing in network flows is performed by utilizing a Reconfigurable Match-Action Table (RMT) model or a pipelined architecture to scale line rates. The RMT model also enables a Protocol-independent Switch Architecture (PISA). With the increased performance of network interfaces, there is a corresponding need for faster packet processing.

### SUMMARY

Existing packet processing architectures are typically stateless, while emerging network applications including virtualization and Artificial Intelligence (AI) require high speed and frequent operations based on a maintained shared state within the network. Next generation AI applications will require network flow policies to be managed on the fly, rather than with traditional ways to configure the match-actions. In other words, the intelligence to manage the flow needs to be within a network switch flow processor not externally loaded and statically applied (e.g., RMT). Because of this mismatch, emerging applications may be significantly limited by the capabilities of in-network computing. Additionally, with increased network bandwidth comes increased pipeline states, which consume more power.

RMT is efficient for sequential data processing with pipeline and data flow; and field-programmable gate array (FPGA) architectures are more efficient for high parallelism. However, neither RMT or FPGA provides support for stateful packet flows and as the number of connections scale over thousands to millions, maintaining stateful packet processing will be critical.

Referring to FIG. 5, the graph 500 illustrates the scaling of architectures compared to sequential versus parallel command processing. For pipelined architecture (e.g., von Neumann 502), single cycle pipelines can consume large amounts of processing time as denoted at the left. As the number of pipeline stages increase, the pipeline cycle time drops, improving the line rate as defined by the downwards slope. On the other hand, the data flow/FPGA architecture has built-in hardware parallelism that can operate on less cycles. Therefore, the data flow architecture is better scalable for increased parallelism. As packet processing stages get complex and increase in number of steps then the data flow line rate gets affected as defined by the upwards slope (e.g., Data flow—FPGA 504).

The techniques described herein relate to improved methods, systems, devices, and apparatuses that provide packet processing techniques which support a hybrid pipelined-data flow packet processing architecture by normalizing sequential and parallel data paths along with scaling in network compute and stateful network flows (e.g., Hybrid pipelined-data flow packet processing 506).

A dataflow controller to perform hybrid packet processing is provided, the dataflow controller comprising: a configuration interface to receive state data, policy data, scheduling data, and dataflow operation data; a data flow interface to process data packets based on configured or dynamically updated states, policies, scheduling, and dataflow operations; a computer interface to perform arithmetic logic unit (ALU/)program execution operations (e.g., fetch of program is not required as it is configured by configuration interface) on data packets based on incoming and outgoing data and control planes; and one or more circuits to intelligently configure a packet processing flow based on at least one of the state data, the priority data, the scheduling data, and the dataflow operation data.

A system is provided that includes: a communication interface to receive state data, policy data, scheduling data, and dataflow operation data; and control logic to process data packets based on configured or dynamically updated states, policies, scheduling, and dataflow operations; to perform ALU/program execution operations on data packets based on incoming and outgoing data and control planes; and to intelligently configure a packet processing flow based on at least one of the state data, the priority data, the scheduling data, and the dataflow operation data.

A machine-readable medium is provided having data stored thereon, which if executed by one or more processors, cause the one or more processors to: receive state data, policy data, scheduling data, and dataflow operation data; process data packets based on configured or dynamically updated states, policies, scheduling, and dataflow operations; perform ALU/program execution operations on data packets based on incoming and outgoing data and control planes; and intelligently configure a packet processing flow based on at least one of the state data, the priority data, the scheduling data, and the dataflow operation data.

A method of receiving state data, policy data, scheduling data, and dataflow operation data; processing data packets based on configured or dynamically updated states, policies, scheduling, and dataflow operations; performing ALU/program execution operations on data packets based on incoming and outgoing data and control planes; and intelligently configuring a packet processing flow based on at least one of the state data, the priority data, the scheduling data, and the dataflow operation data.

A machine-readable medium is provided having data stored thereon, which if executed by one or more processors, cause the one or more processors to: process data packets based on configured or dynamically updated states, policies, scheduling, and dataflow operations; perform ALU/program execution operations on the data packets based on incoming and outgoing data and control planes; and intelligently configure a packet processing flow based on at least one of the configured or dynamically updated states, policies, scheduling, and dataflow operations.

A method of processing data packets based on configured or dynamically updated states, policies, scheduling, and dataflow operations; performing ALU/program execution operations on the data packets based on incoming and outgoing data and control planes; and intelligently configuring a packet processing flow based on at least one of the state data, the priority data, the scheduling data, and the dataflow operation data.

Examples may include one of the following features, or any combination thereof.

In some examples of the device, method, system, and machine-readable medium described herein, a synchronization element to synchronize changes to the packet processing flow, wherein the synchronization element comprises an instruction and command queue.

In some examples of the device, method, system, and machine-readable medium described herein, wherein the dataflow operation data and/or updated dataflow operations is received from a dynamically programmable parser.

In some examples of the device, method, system, and machine-readable medium described herein, wherein the state data and/or updated states is associated with an application.

In some examples of the device, method, system, and machine-readable medium described herein, wherein the state data and/or updated states indicates the application is idle, and wherein the packet processing flow is configured to ignore packets associated with the idle application.

In some examples of the device, method, system, and machine-readable medium described herein, wherein the state data and/or updated states indicates a pipeline stage.

In some examples of the device, method, system, and machine-readable medium described herein, wherein a neural network or similar mechanism such as reinforcement learning engine using Artificial Intelligence determines and outputs the policy data and/or updated polices.

In some examples of the device, method, system, and machine-readable medium described herein, wherein the policy data and/or updated policies comprises a policy to improve bandwidth and/or latency and/or PPS (packets processed per second), and wherein the dataflow controller configures the packet processing flow based on the policy to improve bandwidth and/or latency and/or PPS (packets processed per second).

In some examples of the device, method, system, and machine-readable medium described herein, wherein the policy data and/or updated policies comprises a policy to perform parallel and/or pipelined operations, and wherein the dataflow controller configures the packet processing flow based on the policy to perform parallel and/or pipelined operations. (these operations are performed without assist from main CPU complex that configures hybrid packet processing controller)

In some examples of the device, method, system, and machine-readable medium described herein, wherein the policy data and/or updated policies comprises a policy to improve security, and wherein the dataflow controller configures the packet processing flow based on the policy to improve security.

In some examples of the device, method, system, and machine-readable medium described herein, wherein the scheduling data and/or updated scheduling comprises priority data for a packet stream.

In some examples of the device, method, system, and machine-readable medium described herein, wherein the scheduling data and/or updated scheduling comprises priority data for an application.

In some examples of the device, method, system, and machine-readable medium described herein, wherein the scheduling data and/or updated scheduling comprises an amount of time assigned to a specific task.

In some examples of the device, method, system, and machine-readable medium described herein, wherein intelligently configuring the packet processing flow is based on the state data, the priority data, the scheduling data, and the dataflow operation data.

In some examples of the device, method, system, and machine-readable medium described herein, wherein intelligently configuring the packet processing flow is based on the updated states, policies, scheduling, and the dataflow operations.

In some examples of the device, method, system, and machine-readable medium described herein, wherein intelligently configuring the packet processing flow is based on at least two of: the state data, the priority data, the scheduling data, and the dataflow operation data.

### BRIEF DESCRIPTION OF THE DRAWINGS

FIG. 1 illustrates prior art examples of packet processing.

FIG. 2 illustrates an example of a system for hybrid pipelined-data flow packet processing architecture in accordance with aspects of the present disclosure.

FIG. 3 illustrates an example of a process flow for performing hybrid pipelined-data flow packet processing in accordance with aspects of the present disclosure.

FIG. 4 illustrates an example system for hybrid pipelined-data flow packet processing architecture in accordance with aspects of the present disclosure.

FIG. 5 illustrates the scaling of architectures compared to sequential versus parallel command processing.

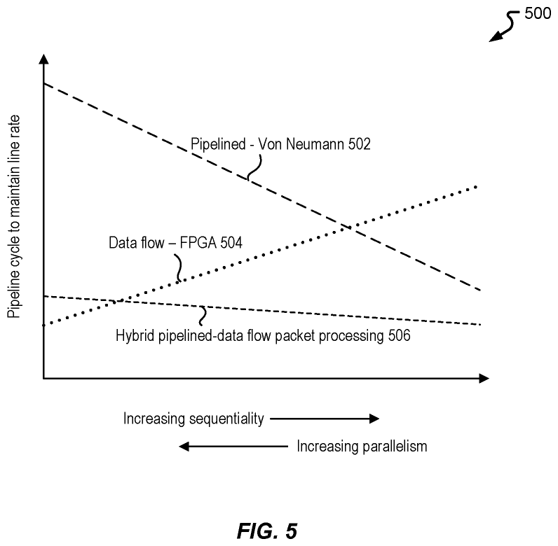

### DETAILED DESCRIPTION

The ensuing description provides example aspects of the present disclosure, and is not intended to limit the scope, applicability, or configuration of the claims. Rather, the ensuing description will provide those skilled in the art with an enabling description for implementing the described examples, it being understood that various changes may be made in the function and arrangement of elements without departing from the spirit and scope of the appended claims. Various aspects of the present disclosure will be described herein with reference to drawings that are schematic illustrations of idealized configurations.

Example aspects of the present disclosure provide packet processing techniques which support a hybrid pipelined-data flow packet processing architecture by normalizing sequential and parallel data paths along with scaling in network compute and stateful network flows. In some cases, the techniques described herein may be applied to telecommunication (e.g., fourth generation (4G) telecommunication networks, fifth generation (5G) telecommunication networks, etc.) and Internet of Things (IoT) rich environments.

Aspects of a cloud infrastructure and/or local network infrastructure may be implemented by a programmable networking infrastructure, which includes packet processing. In some examples, the programmable networking infrastructure may be implemented through Software-Defined Networking (SDN) and Network Functions Virtualization (NFV) techniques. In some aspects, the programmable networking infrastructure may support software-based flow management (e.g., management of packets associated with different packet flows).

Aspects of the disclosure are further illustrated by and described with reference to apparatus diagrams, system diagrams, and flowcharts that relate to a hybrid pipelined-data flow packet processing architecture.

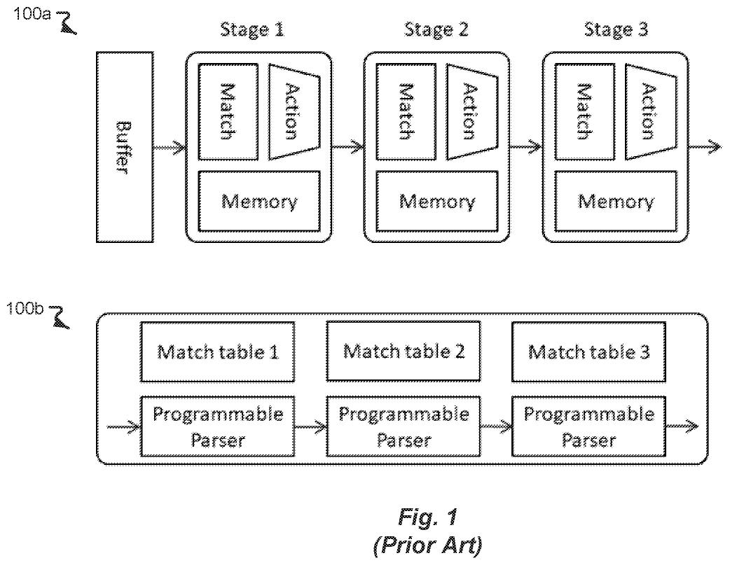

Two packet processing protocols in existing architectures include: Re-Configurable Match-Action Tables (RMTs) and data flow-based implementations (e.g., implemented via field-programmable gate array (FPGA)). FIG. 1 illustrates the two different approaches.

In the RMT approach (e.g., FIG. 1 100a), a pipeline for packet processing might include many parallel pipes. The header fields and meta data are processed for each incoming packet, and a match-action pipeline stage implements a lookup table using Content-Addressable Memory and an action module encompassing multiple arithmetic-logic units (e.g., ALUs based on reduced instruction set computer (RISC) processors with shifts, arithmetic, logical or comparisons operators). RMT offers a protocol independent flow of packets through the pipeline. Each stage is simple and takes few clock cycles and with multiple pipelines the line rate can be maintained as each pipeline can complete the processing at almost every clock.

While RMT based packet processing executes instructions, FPGA or data flow-based implementations (e.g., FIG. 1 100b) utilize programmable parsers that do not require instruction pipelines that compile and download static flows. Each programmable parser is programmed with instruction(s) and as packets flow through they are processed.

The fundamental delta between dataflow and von Neumann processing models (e.g., control plane) appear to place them at two ends of a spectrum. The von Neumann compute is composed of Control Flow, Control Dataflow, instruction decode and fetch pipelines and ALU where operands and operator are part of register data flow. Whereas with data flow models, data is transmitted from one stage to another in the form of tokens and operations are performed while data is flowing through the stages.

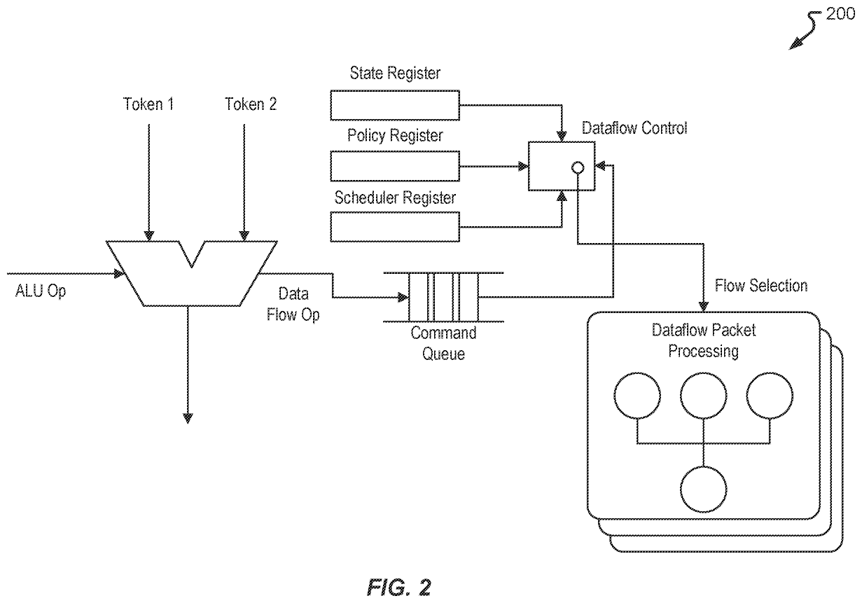

FIG. 2 illustrates the hybrid packet flow processing according to the present disclosure. Special purpose instruction may trigger the flow operation where data flow operations are programmed in a pre-configured fashion. To execute a required flow, dataflow control considers data from state register (e.g., state data), policy register (e.g., policy data) and scheduling registers (e.g., scheduling/priority data) and defines a flow selection to execute. Based on Artificial Intelligence (AI) or any other means (e.g., neural network), state, policy and scheduling registers can be updated impacting the flow operation execution (e.g., on the fly execution). In order to maintain synchronization when new flows are implemented, a synchronizer (e.g., command queue) may be included. In embodiments, the synchronizer may queue packets for processing.

With the hybrid packet flow processing, instead of being static, packet processing is dynamically adaptive and scalable to AI as well as in memory network and compute. The present disclosure may be applied to both a central processing unit (CPU) and/or a graphic processing unit (GPU). Compared to the established packet processing flows, the present disclosure allows for block level granularity in packet processing rather than single instruction execution. In other words, packet processing flow(s) are intelligently configured based on at least one of the state data, the priority data, the scheduling data, and the dataflow operation data (e.g., flow selection) and the packets are processed using the intelligently configured flows (e.g., dataflow packet processing).

Additionally, data flow block execution scheduling, state tracking and policy-based action selection are added. The state management can be assisted through in network compute and policy selection can be assisted through AI algorithms. Similarly, scheduling policies can be applied as a function of various priority models. In embodiments, the command queue comprises a synchronization mechanism for managing dynamic changes to the packet processing flow, as, for example, queuing packets while the packet processing flow is updated. In another example, the synchronization mechanism may queue packets based on the scheduling and/or priority data.

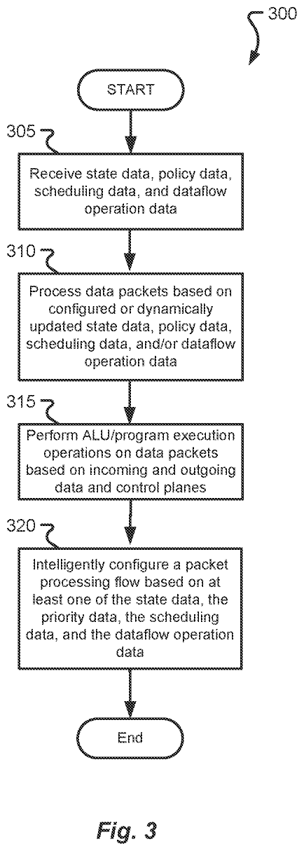

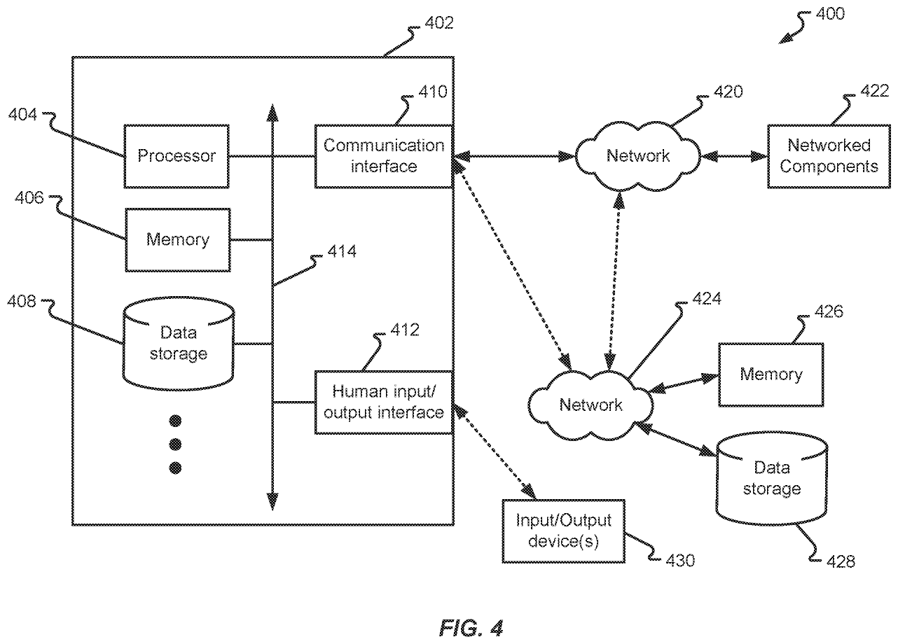

FIG. 3 illustrates an example of a process flow 300 for hybrid packet flow processing in accordance with aspects of the present disclosure. In some examples, process flow 300 may implement aspects of a system/dataflow controller 200 and/or a device 402 described with reference to FIGS. 2 and 4.

In the following description of the process flow 300, the operations may be performed in a different order than the order shown, or the operations may be performed in different orders or at different times. Certain operations may also be left out of the process flow 300, or other operations may be added to the process flow 300.

In step 305, state data, policy data, scheduling data, and dataflow operation data are received. In embodiments, the state data, policy data, scheduling data, and dataflow operation data may be configured and/or dynamically updated.

In embodiments, state data keeps track of sessions or transactions for each packet (e.g., stateful packet processing). Examples of policies (e.g., policy data) include optimizing bandwidth, security, parallelize operations, etc. In embodiments, the policy data may be output from an AI/neural network. Scheduling data may include how much time is assigned (e.g., clocks/CPU speed). Packets may be associated with specific applications that may be running or idle. Packets associated with idle applications may have a lower priority for processing compared to packets associated with running applications. In another example, certain polices may indicate which packets to prioritize. Scheduling data may also include a function of network slack time for a packet. For example, for firewall applications, connection tracking, gateway interfaces, packet dropping etc., which may also be deployed by the control path functionality and not limited to example described above. Dataflow operation data may include parallelization and distribution, optimization, automatic tuning features, etc.

In step 310, data packets are processed based on configured or dynamically updated state data, policy data, scheduling data, and/or dataflow operation data. For example, the packets are processed based on the system 200 as configured when the packets are received. Packets may be processed sequentially, in parallel, or both.

In step 315, the system 200 (e.g., a dataflow controller) performs ALU/program execution operations on data packets based on incoming and outgoing data and control planes. For example, the ALU can continue to perform allocation of policies and states while data flow modules continue to execute. Additionally, AI based policy selection, as the states change the action selection probability, can be managed through the dataflow control (e.g., stateful packet processing).

In step 320, a packet processing flow is intelligently configured based on at least one of the state data, the priority data, the scheduling data, and the dataflow operation data. Packet processing is dynamically adaptive and scalable to AI as well as in memory compute. For example, the system 200 is dynamically configured on the fly to process the packets based on information associated with the packets. That is to say, the policy data, scheduling data, and dataflow operation data, etc., may be changed on the fly. Additionally, packet flow processing control can be configured with existing frameworks such as open flow, Data Plane Development Kit (DPDK) and Mellanox ASAP. Mechanisms described in this invention are general purpose and configurable to be able to be used with any similar frameworks.

FIG. 4 depicts system 402 in system 400 in accordance with embodiments of the present disclosure. System 402 may be an example of the system 200.

The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414.

In other embodiments, processor 404 may comprise a shared processing device that may be utilized by other processes and/or process owners, such as in a processing array within a system (e.g., blade, multi-processor board, etc.) or distributed processing system (e.g., “cloud,” farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally, or alternatively, human input/output interface 412 connects to one or more interface components to receive and/or present information (e.g., instructions, data, values, etc.) to and/or from a human and/or electronic device.

Examples of input/output device(s) 430 that may be connected to an input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or utilize one or more networks, such as network 420 and/or network 424. Input/output device(s) 430 may be accessed by processor 404 via human input/output interface 412 and/or via communication interface 410 either directly, via network 424 (not shown), via network 420 alone (not shown), or via networks 424 and 420 (not shown).

Networks 420 and 424 may be a wired network (e.g., Ethernet), wireless (e.g., Wi-Fi, Bluetooth, cellular, etc.) network, or combination thereof and enable device 402 to communicate with networked component(s) 422 (e.g., automation system). In other embodiments, networks 420 and/or 424 may be embodied, in whole or in part, as a telephony network (e.g., public switched telephone network (PSTN), private branch exchange (PBX), cellular telephony network, etc.).

Components attached to network 424 may include memory 426 and data storage 428. For example, memory 426 and/or data storage 428 may supplement or supplant memory 406 and/or data storage 408 entirely or for a particular task or purpose. For example, memory 426 and/or data storage 428 may be an external data repository (e.g., server farm, array, “cloud,” etc.) and allow device 402, and/or other devices, to access data thereon. Each of memory 406 and data storage 408, memory 426, data storage 428 comprise a non-transitory data storage comprising a data storage device.

Any of the steps, functions, and operations discussed herein can be performed continuously and automatically.

The exemplary apparatuses, systems, and methods of this disclosure have been described in relation to examples of a telemetry collection device 115. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

It will be appreciated from the descriptions herein, and for reasons of computational efficiency, that the components of devices and systems described herein can be arranged at any appropriate location within a distributed network of components without impacting the operation of the device and/or system.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

While the flowcharts have been discussed and illustrated in relation to a particular sequence of events, it should be appreciated that changes, additions, and omissions to this sequence can occur without materially affecting the operation of the disclosed examples, configuration, and aspects.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed example, configuration, or aspect. Thus, the following claims are hereby incorporated into this Detailed Description, with each claim standing on its own as a separate preferred example of the disclosure.

Other variations are within spirit of present disclosure. Thus, while disclosed techniques are susceptible to various modifications and alternative constructions, certain illustrated examples thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed examples (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one example, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain examples require at least one of A, at least one of B and at least one of C each to be present. In addition, unless otherwise noted or contradicted by context, term “plurality” indicates a state of being plural (e.g., “a plurality of items” indicates multiple items). In at least one example, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one example, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one example, code is stored on a computer-readable storage medium, for example, in form of a computer program comprising a plurality of instructions executable by one or more processors. In at least one example, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one example, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one example, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one example, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one example, different components of a computer system have separate processors and different processors execute different subsets of instructions.

Accordingly, in at least one example, computer systems are configured to implement one or more services that singly or collectively perform operations of processes described herein and such computer systems are configured with applicable hardware and/or software that enable performance of operations. Further, a computer system that implements at least one example of present disclosure is a single device and, in another example, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate examples of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work overtime, such as tasks, threads, and intelligent agents. Also, each process may refer to multiple processes, for carrying out instructions in sequence or in parallel, continuously or intermittently. In at least one example, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one example, process of obtaining, acquiring, receiving, or inputting analog and digital data can be accomplished in a variety of ways such as by receiving data as a parameter of a function call or a call to an application programming interface. In at least one example, processes of obtaining, acquiring, receiving, or inputting analog or digital data can be accomplished by transferring data via a serial or parallel interface. In at least one example, processes of obtaining, acquiring, receiving, or inputting analog or digital data can be accomplished by transferring data via a computer network from providing entity to acquiring entity. In at least one example, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A dataflow controller to perform hybrid packet processing, the dataflow controller comprising:
a configuration interface to receive state data, policy data, scheduling data, and dataflow operation data;
a data flow interface to process data packets based on configured or dynamically updated states, policies, scheduling, and dataflow operations;
a computer interface to perform arithmetic logic unit (ALU)/program execution operations on the data packets based on incoming and outgoing data and control planes; and
one or more circuits to intelligently configure a packet processing flow based on at least one of the state data, the policy data, the scheduling data, and the dataflow operation data.

2. The dataflow controller of claim 1, further comprising:
a synchronization element to synchronize changes to the packet processing flow, wherein the synchronization element comprises an instruction and command queue.

3. The dataflow controller of claim 1, wherein the dataflow operation data is received from a dynamically programmable parser.

4. The dataflow controller of claim 1, wherein the state data is associated with an application.

5. The dataflow controller of claim 4, wherein the state data indicates the application is idle, and wherein the packet processing flow is configured to ignore packets associated with the idle application.

6. The dataflow controller of claim 1, wherein the state data indicates a pipeline stage.

7. The dataflow controller of claim 1, wherein a neural network or similar mechanism such as reinforcement learning engine using Artificial Intelligence determines and outputs the policy data and/or the updated policies.

8. The dataflow controller of claim 1, wherein the policy data comprises a policy to improve bandwidth and/or latency and/or PPS (packets processed per second), and wherein the dataflow controller configures the packet processing flow based on the policy to improve bandwidth and/or latency and/or PPS (packets processed per second).

9. The dataflow controller of claim 1, wherein the policy data comprises a policy to perform parallel and/or pipelined operations, and wherein the dataflow controller configures the packet processing flow based on the policy to perform parallel and/or pipelined operations.

10. The dataflow controller of claim 1, wherein the policy data comprises a policy to improve security, and wherein the dataflow controller configures the packet processing flow based on the policy to improve security.

11. The dataflow controller of claim 1, wherein the scheduling data comprises priority data for a packet stream.

12. The dataflow controller of claim 1, wherein the scheduling data comprises priority data for an application.

13. The dataflow controller of claim 1, wherein the scheduling data comprises an amount of time assigned to a specific task.

14. The dataflow controller of claim 1, wherein intelligently configuring the packet processing flow is based on the state data, the policy, the scheduling data, and the dataflow operation data.

15. The dataflow controller of claim 1, wherein intelligently configuring the packet processing flow is based on at least two of: the state data, the policy data, the scheduling data, and the dataflow operation data.

16. A method to perform hybrid packet processing, the method comprising:
receiving state data, policy data, scheduling data, and dataflow operation data;
processing data packets based on configured or dynamically updated states, policies, scheduling, and dataflow operations;
performing arithmetic logic unit (ALU)/program execution operations on the data packets based on incoming and outgoing data and control planes; and
intelligently configuring a packet processing flow based on at least one of the state data, the policy data, the scheduling data, and the dataflow operation data.

17. The method of claim 16, further comprising:
synchronizing changes in the packet processing flow.

18. The method of claim 16, wherein the dataflow operation data is received from a dynamically programmable parser.

19. The method of claim 16, wherein the state data is associated with an application.

20. The method of claim 19, wherein the state data indicates the application is idle, and wherein the packet processing flow is configured to not process packets associated with the idle application.
